(19) United States
(12) Patent Application Publication
(10) Pub. No.: US 2004/0117402 A1
(43) Pub. Date: Jun. 17, 2004

(54) Data retrieval system

(76) Inventors: Jane E Tateson, Wickham Market (GB); Richard E Tateson, Wickham Market (GB)

Correspondence Address: Nixon & Vanderhye, 8th Floor, 1100 North Glebe Road, Arlington, VA, 22201-4714, US

(21) Appl. No.: 10/471,424

(22) PCT Filed: Mar. 12, 2002
(86) PCT No.: PCT/GB02/01107

(30) Foreign Application Priority Data
Mar. 28, 2001 (EP) 01302892.3

(51) Int. Cl. G06F 17/00

(52) U.S. Cl. 707/104.1

(57) ABSTRACT

An on-line database searching system uses a product selection process performing an evolutionary search strategy, with the user acting as the selective pressure, using “mutations” based on the most recent selection or selections. The selections are mutated by varying characteristics of the items selected to define a new set of characteristics, and further items having the newly selected character set are then selected for consideration by the user. By selecting in a multidimensional range of characteristics, such a process can create a serendipitous exploration of the ‘search space’, more akin to the browsing process used in a real shop than the typical branched search approach of existing catalogue-based systems.

This invention relates to data retrieval systems, and in particular to systems for assisting users making a selection from a large range of available items. It has application in searchable databases in which there are a large number of variables to consider and the user needs freedom to search according to his own preferred criteria, but the database is too large, or the user's criteria too poorly defined, for a fully structured search to be possible.

In searchable databases a searcher is generally forced to navigate along a branching decision ‘tree’ towards a destination that will hopefully be what he wants. This is a good method for searching towards a known objective. However, because paths must be retraced to arrive at different destinations such a system is not so good for less structured searching (“browsing”) where the objective is less clearly defined, or where several objectives may need to be inspected. The searcher is entirely at the mercy of the database's categorisation and will be unlikely to make chance finds, or form a general impression of what is available and thus direct his choices (a common strategy when shopping for clothes for example).

The shortcomings of online searching are magnified still further when the bandwidth of the link between the user and the database is low. An attempt to ‘browse’ an online database via a modem, for example, typically consists of a pause while the homepage loads, a relatively rapid selection by the searcher of a section within the database, another pause while the section page loads, rapid selection of a category of items, a further pause, etc. etc. Mobile access to the internet will mean that relatively low bandwidth online searching is likely to continue to grow even as people adopt high bandwidth connections for their fixed links.

According to the invention there is provided an apparatus for selecting items from a database for display, comprising a data-storage means for storing, for each item, data indicative of the degree of similarity between that item and other items in the database;

input means for receiving a user input identifying a first item in said database

evolution processor means for specifying an evolved specification having a predetermined degree of similarity to the first item,

identifying from the database one or more variant items meeting the evolved specification,

selection means for selecting a second item from amongst the variant items

and output means for displaying an output identifying the selected second item.

The invention also extends to a method of selecting items from a database for display, comprising the steps of:

generating data indicative of the similarity between each item and other items in the database;

receiving an input identifying a first item in said database;

generating an evolved specification, identifying a predetermined degree of similarity to the first item,

selecting an item in the database meeting the evolved specification,

displaying the selected second item.

The invention also extends to a computer program for performing the method of the invention, and to a computer program product directly loadable into the internal memory of a computer, comprising software code portions for performing the steps of the method when the product is run on a computer.

The invention also extends to a computer program product stored on a computer usable medium, comprising:

computer-readable program means for causing a computer to generate data indicative of the similarity between each item and other items in a database

computer-readable program means for causing the computer to receive an input identifying a first item in said database

computer-readable program means for generating an evolved specification, specifying a predetermined degree of similarity to the first item,

computer-readable program means for causing the computer to select an item in the database meeting the evolved specification,

computer-readable program means for causing the computer to generate a display of the selected second item.

Preferably a plurality of items are displayed, and the input means has means for selecting one of the displayed items to be the first item. In a preferred arrangment the output means has means for controlling the display means to replace one of the plurality of items, preferably the item which has been displayed for longest without having been selected, by the selected second item. This can be an iterative process wherein the selected second item is added to the display, a further input being received relating to one of the displayed items, for selection of a further item for display. In order to identify which item is to be replaced, each displayed item may be allocated an age value, the age value being initially set at zero and incremented periodically, the age value of a given displayed item being reset to zero if that item is selected, and the age values being used to identify items for deletion from the display. Selection of the second item may be constrained to prevent selection of the same item within a predetermined number of iterations of the process.

The process, when allowed to repeat itself iteratively, allows the product selection process to perform an evolutionary search strategy with the user acting as the selective pressure, using “mutations” based on the most recent selection or selections. Such a process can create a serendipitous exploration of ‘search space’, more akin to the natural browsing process used in a shop or library.

Existing evolutionary search strategies can be thought of as optimisation processes where the goal is to find the best set of values for the n dimensions of the search space. For example if n=1, i.e. there is a single dimension ‘x’, the goal is to find the value of x for which some function f(x) is maximal. A number of ‘individuals’ are created with different values for x. The individuals that have high values for f(x) are ‘rewarded’ with more “children” than individuals giving low values for f(x). The children of an individual have values for “x” which are similar to, but not identical to, the value of x for that individual. All the children are then evaluated according to their values for f(x), and rewarded with children accordingly. This process iterates until some termination condition is met.

Continuously or discretely varying dimensions can be searched in this way, provided the ‘mutation’ operators which dictate how a child's value may vary from its parent's are constructed appropriately. For example, if x can take integer values from 1 to 100, an obvious mutation operator would be to add or subtract 1 from the parent's value to give the child's value (with suitable ‘boundary conditions’ to avoid less than 1 or more than 100). If x can take any real value from 1 to 100, the mutation operator might be to perturb the child's value according to some probability distribution around the parent's value (with boundary conditions again).

In the invention the goal is to find the best item in a database. This is an inherently discrete search—as the number of items in the database is finite. It should be noted that in the context of browsing the criteria defining “best” are not defined initially.

In one version of the invention these items are described according to n attributes, and those attributes are the n dimensions for an evolutionary search. Each item may be allocated specified values for each of the set of attributes, (the degree of similarity between any two items being identifiable by the number of attributes for which the two items have values in common). Items are displayed to the user, and rather than evaluating each item according to some objective function, the ‘optimality’ or ‘fitness’ of each item is determined by rewards from the subjective user. The more rewarded items have a greater chance of contributing to the next generation. As in evolutionary search, a child is generated by ‘mutating’ the attributes of the parent. The evolved specification is therefore selected by generating a set of attribute values differing by a predetermined degree from the set of attribute values of the first item, the second item being selected from the database from those having attribute values corresponding to the generated set of attribute values. However, it is possible that the n dimensional search space will not precisely match the database. There may be some values of the n attributes, which do not correspond to any item in the database. Conversely for some sets of n values there may be more than one item. Therefore we could create a notional ‘child’, which does not actually exist in the database, or a child that corresponds to several real items in the database. The process of choosing the next item to display allows for both these possibilities.

The evolved specification may be determined according to the attributes of two or more previous inputs, and to this end the apparatus may comprise recording means for recording the selections made on each cycle of operation of the apparatus, wherein the attribute generation means is arranged to generate a set of attributes related to attributes of items recorded as having been selected within a predetermined number of previous cycles of operation of the apparatus

A special attribute set may be defined for each item, each attribute of the set representing, not properties such as colour, etc, but the degree of similarity between that item and some other item. For each item in the search space, there would be one of these attributes relating to each other item in the search space. Each specified value may simply define the presence or absence of an association between the two items. In this embodiment the search space may be considered to be organised as a connected graph. In other words, rather than using the same set of attributes to organise (or ‘create’) search space, and to navigate it, navigation of the space follows a series of connected points. The evolved specification can then be generated by specifying a predetermined value for the term of each attribute set relating to the first item.

In order to achieve this the system operator of the search space must first determine what items should be “adjacent” to each other. This may be done by a human operator, or in a semi-automated process in which every item is given values for a set of attributes and then placed in a search space that has the same number of dimensions as there are attributes. Every item then has a set of neighbours, defined as being those items located in this space within a specified distance. Again, this distance may reduce on successive iterations of the process. Navigation is carried out by moving from the selected items to one of its set of neighbours. This constitutes a “mutation”.

In a further embodiment the space is once again organised as a connected graph, but rather than allowing navigation to follow a series of connected points, the next item to display may be taken from anywhere in the database. Each attribute may be associated with a weighting value, such that on receipt of an input relating to a first item, the weighting values of the attributes associated with the first item are increased, and the evolved specification is generated such that items having attributes allocated higher weightings have a greater probability of selection than those with lower-weighted attributes. Clicking on an item rewards all items connected to that item. When choosing the next item to display, this method biases the choice according to the number of rewards accumulated by items over the course of the search.

The generated set of attribute values may be determined according to the attributes of two or more previous inputs, and the selections made on each cycle of operation of the apparatus may be recorded, and the selection of the second item constrained to prevent selection of an item recorded by the recording means as having already been selected within a predetermined number of previous cycles of operation of the apparatus.

Although the embodiments to be described are used for on-line retail shopping, and specifically for clothes, many other applications are possible. For example, the invention may be used for fashion material ‘buyers’ to browse towards colours, patterns, textures they like. On-line browsing is also particularly suited to fields of estate agency (real estate) and travel agency, where the products on sale are inherently difficult to display, and auction houses, which have big catalogues of items that, because they are unique, cannot readily be physically displayed to a wide audience. The invention may also be used for selecting other items from a large database, such as “clip-art” images for incorporation in graphic displays such as presentation slides, many databases of which are difficult to browse because of the wide range of criteria under which they might be catalogued. The invention may also be used for on-line news feeds, arranging for pop-up windows with news information having content similar to items previously selected. The invention may also be applied to Identikit or e-fit systems for identifying criminals or missing persons, either by searching through a database of real people, or by generating a face from a witness's description. Rather than being on-line in the usual sense, the invention may be applied to an In-store Kiosk, for finding a desired item using a terminal in a real shop before collecting it from ‘goods out’.

Embodiments of the invention will now be described, by way of example only and with reference to the drawings, in which:

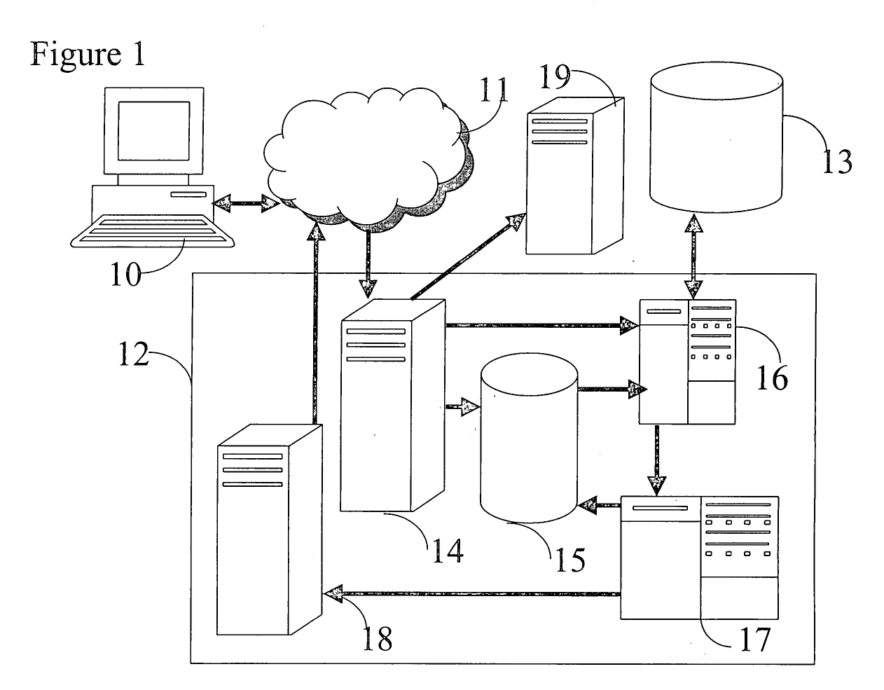

FIG. 1 illustrates schematically the inter-relationships between the various elements that co-operate to perform the invention;

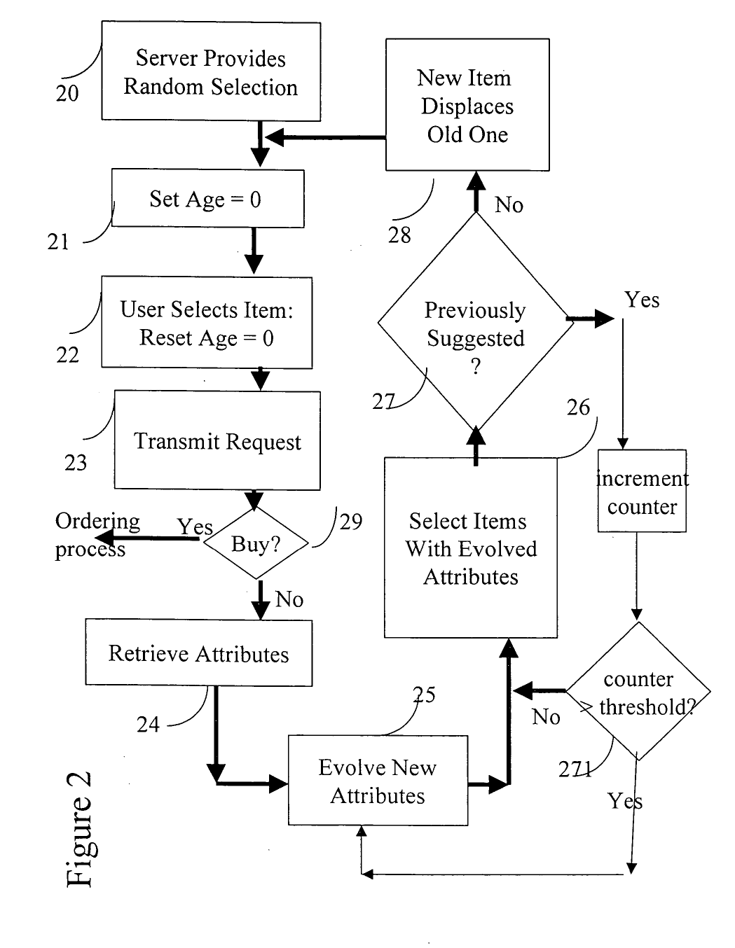

FIG. 2 is a flow chart illustrating the process performed by a first embodiment of the invention;

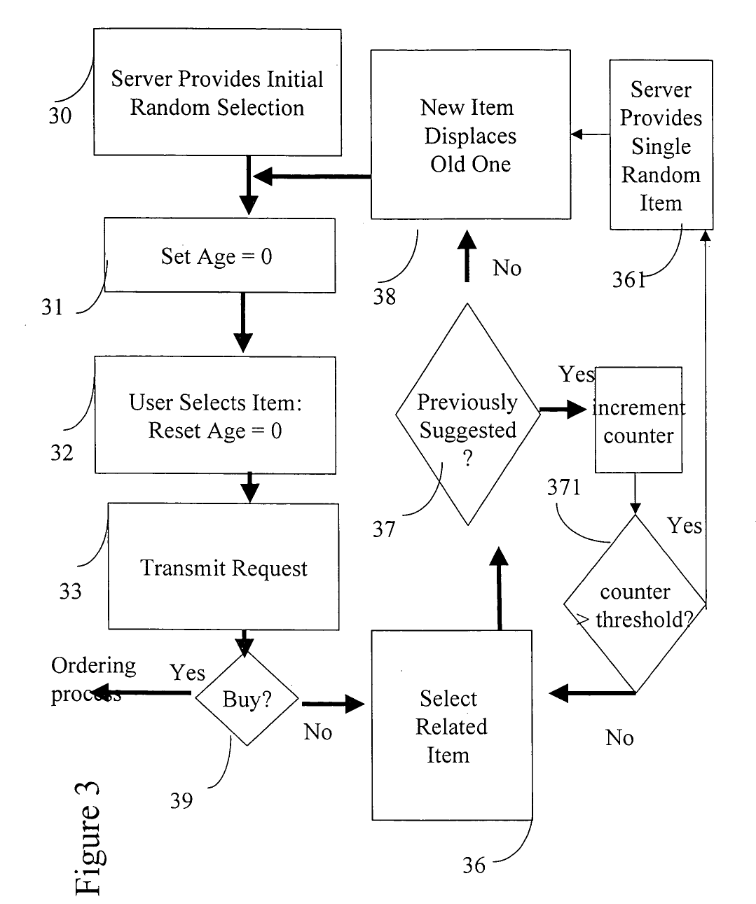

FIG. 3 is a flow chart illustrating the process performed by a second embodiment of the invention;

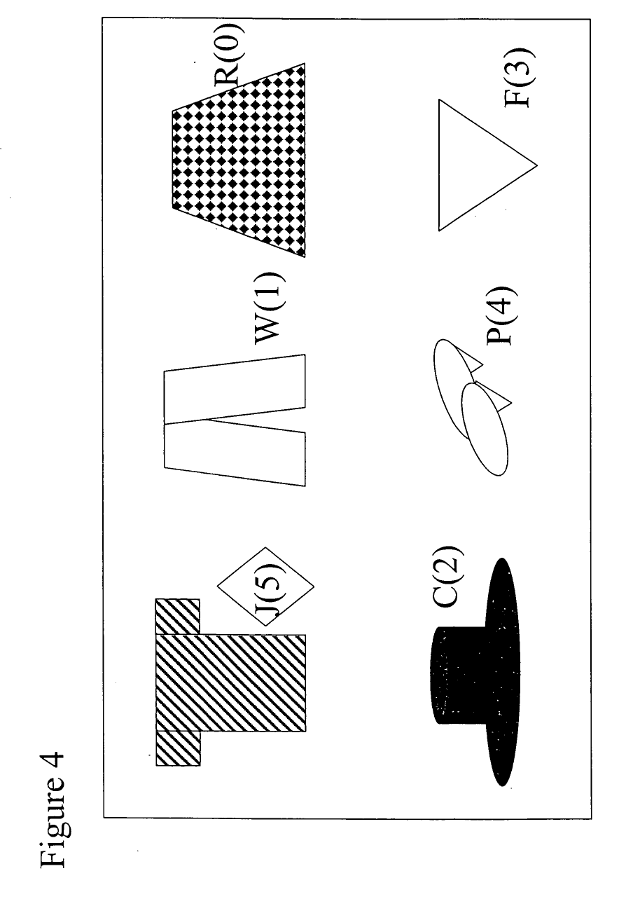

FIGS. 4, 5, 6 and 7 illustrate displays that may appear during an illustrative run of the process.

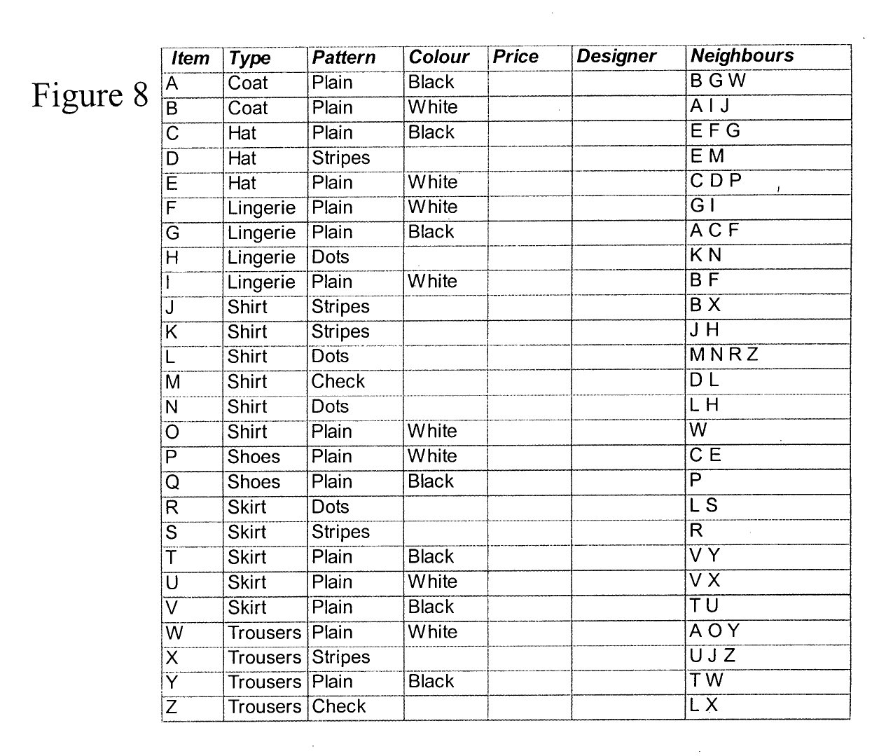

FIG. 8 illustrates the database used to support the processes illustrated in FIGS. 4 to 7.

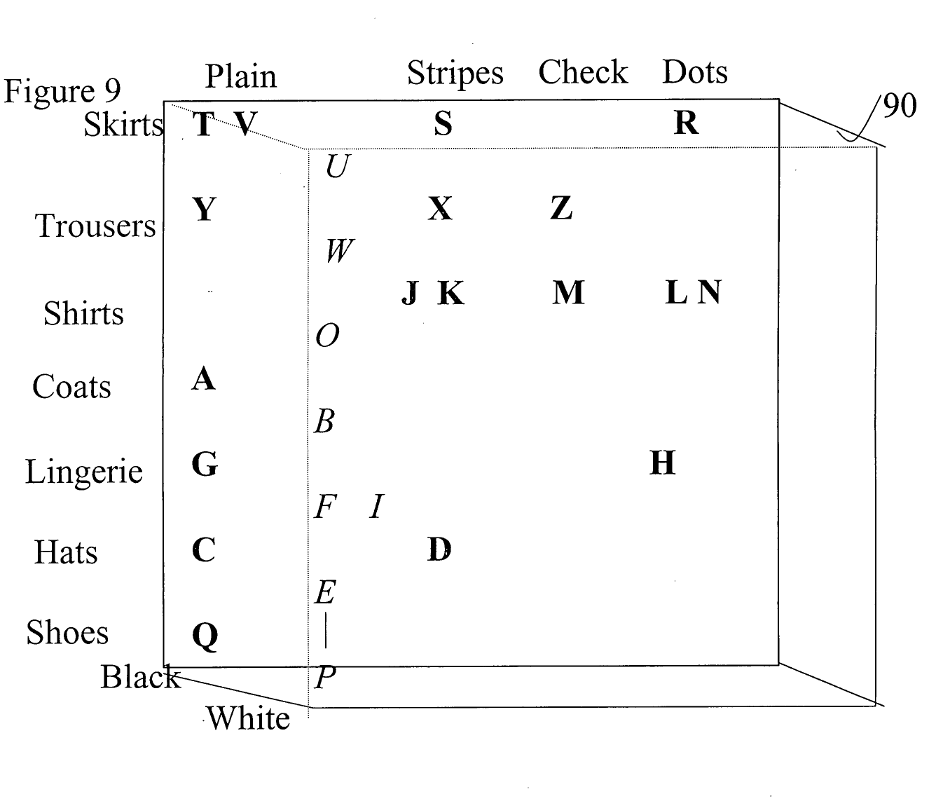

FIG. 9 illustrates in graphical form the data depicted in FIG. 8.

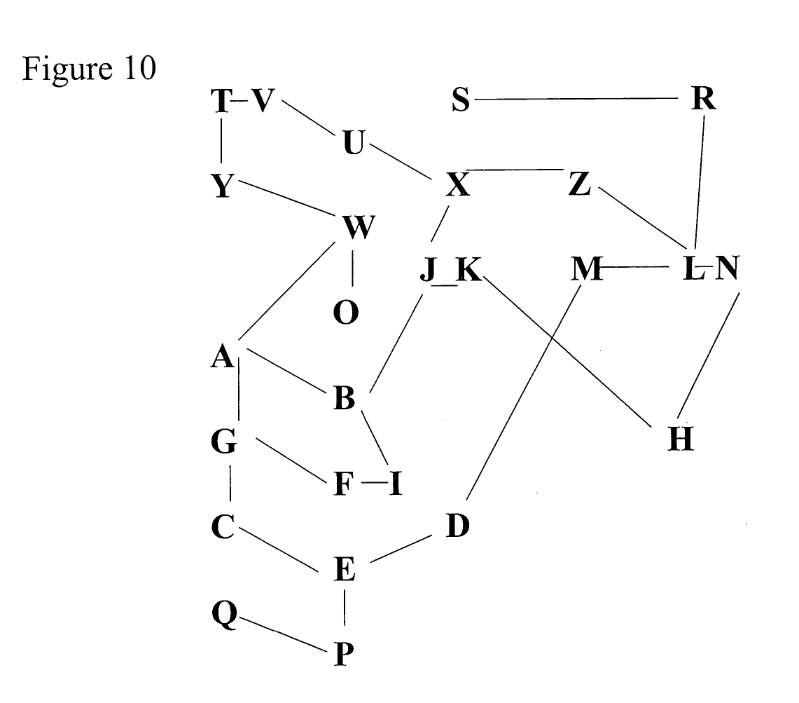

FIG. 10 illustrates the same data in a different graphical form.

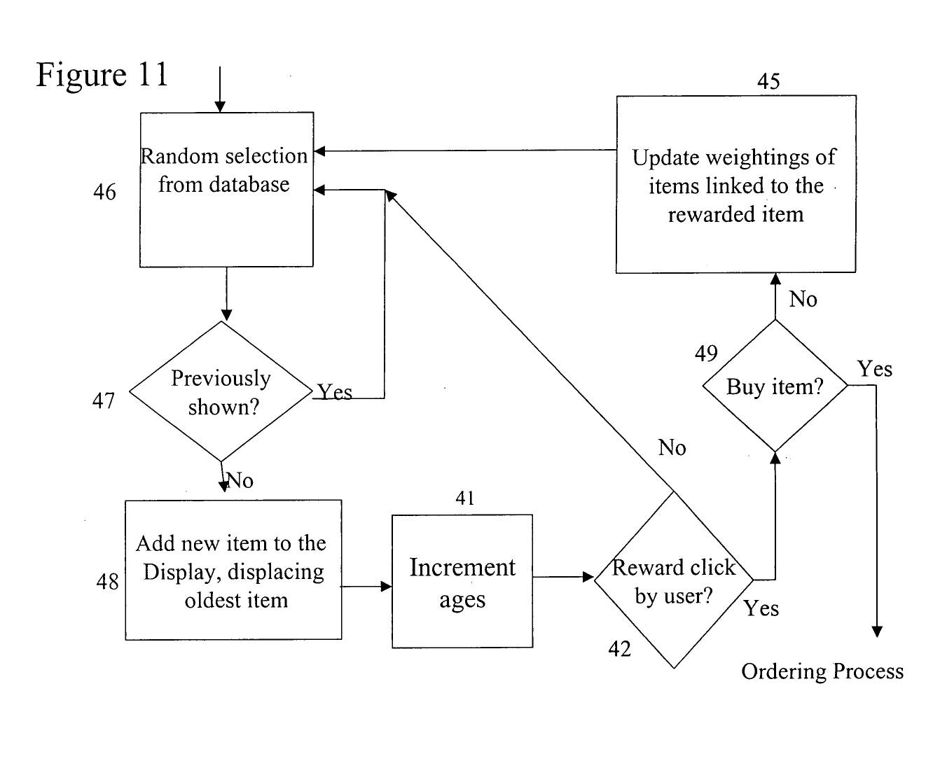

FIG. 11 illustrates a further embodiment of the invention

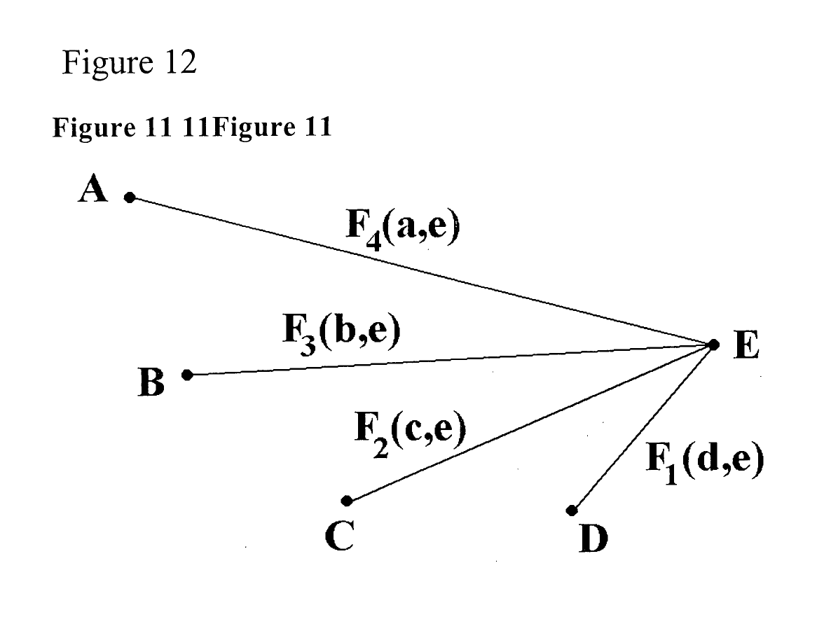

FIG. 12 illustrates an additional step used in a multiple user variant of the embodiments of FIGS. 3 and 11

FIG. 1 illustrates a user terminal 10 connected through a communications network 11 such as a low-bandwidth telephone connection to a server 12. The server has access to a database 13, and itself comprises a number of subsystems, which will typically be implemented by software. These subsystems include a receive port 14, a session recording database 15, an evolution processor 16, a selection processor 17, and an output port 18. An order-processing server 19 is also associated with the system.

It should be understood that the distribution of the elements may be varied. For example a client server, interposed between the network 11 and main server 12, may perform some of the functions performed by the terminal 10 in the described embodiment. Alternatively, the process could be run on the user terminal 10, accessing the data directly from an online database 13.

In use, the system offers the searcher one or more search spaces or ‘gardens’, which can either be held locally or by the service provider. These are the areas within which the searcher, over the course of one or many sessions, will cultivate a collection of items of interest to the user. The service provider creates a ‘search space’ which is a multidimensional space consisting of all items available. A simplified example is shown in FIG. 9. The neighbourhood of an item is populated with items that, in one or more characteristics, are similar to that item.

The database 13 stores a catalogue of all the items available for inspection, classified by a large number of attributes. For example, clothes may be classified by type (shoes, hats, shirts, etc), colour, pattern, style, designer, price and so on.

The database can be set up by manual entry or by extracting data from a catalogue. Items presented in spreadsheet form are particularly suited for compiling the database, using the various column entries as the categories.

The process performed by a first embodiment of the invention is represented in FIG. 2. A searching session operates as follows. The user of the terminal 10 opens a search space or “garden” (new or pre-existing) with a descriptor, which may be general (e.g. ‘clothes’) or more specific (e.g. “trousers”). Certain other limitations may be added to limit the variety of items available for display: in particular the user may specify clothes sizes, to avoid the display of items not available in the user's own size. Subject to any such predetermined limitations, the selection processor 17 selects items, initially at random, from the database 13 and passes them to the output port 18 for onward transmission to the user (step 20). To make the best use of the narrow bandwidth available on most home user's equipment, the output port 18 includes a buffer store so that it can continuously provide the user terminal 10 with items from the database 13. New items then start arriving in the display (description plus picture wherever appropriate). Initially these items are randomly selected from all items within the ‘search space’ shown in FIG. 9, subject to any initial limitations imposed. When the user terminal 10 receives a new item it allocates it an “age” value, which is initially zero (step 21). This characteristic is incremented either in accordance with chronological time or when further items are added to the display, and items achieving a predetermined age are deleted from the garden.

In the simplified illustrated examples shown in FIGS. 4 to 10, a number of items, identified by the characters A, B, C, D . . . Z are available for display. These are stored on the database 13 each with a number of associated attributes. For the purposes of this example only three attribute categories are identified in FIG. 9, namely garment type, colour and pattern. Several further such attributes are listed in FIG. 8, although not used in this example. In practice many different attributes such as price, designer, age group, material, size, etc, would be used. Each item would then have an entry for an attribute in each of these categories (e.g. Designer Paul, Jacket, Grey, plain, adult, wool mixture, 96 cm chest, £60). The attributes may be considered as defining a position in a multidimensional “search space” 90, in which items sharing an attribute would be adjacent to each other in the relevant dimension, as shown for the three illustrative attributes in FIG. 9. (In FIG. 9 the italicisation of items B, E, F, 0, P, U, W represents their location in a different plane from that containing the other items).

Each item to be displayed is selected by choosing values for each category and then picking an item that matches all those values. Initially this selection is unbiased. For example, if there are eleven different designers and eight different garment types, there would be a 1 in 11 chance that ‘Designer Paul’ would be the designer chosen for the first item to display and a 1 in 8 chance that the garment would be a jacket. The user can passively observe items entering the display as long as he likes. At any time the user may identify an item of interest to him. Such an item would be one that attracts the user as being of a kind worthy of further consideration, for example the item “J” in the display of FIG. 4.

When an item is selected the age value of that item is reset to zero (step 22) and a signal is transmitted over the communications link 11 (step 23) to the receive port 14, causing the product identifier to be stored in the session recording database 15. The evolution processor 16 then applies an evolutionary search space technique to the data received. This is the point at which the arrival of new items deviates from a random sample.

In the embodiment of FIG. 2 the evolution processor 16 firstly retrieves the attributes of the selected item J stored in the database 13 (step 24). It then uses these attributes of the selected item to bias the random process of choosing the set of attributes for the next item to display. With this bias included, the choice of attributes is then made and the resulting ‘evolved’ attributes are passed to the selection processor 17 (step 25). In a preferred arrangement the evolution processor 16 uses the history of the last few selections retrieved from the session recording database 15, and not just the current selection, to determine which attributes to influence the biasing of attribute choice. This allows new selections to have more than one “parent”.

As an equation:

P_{ci}=(1+n_{ci})/(N_{c}+nₜₒₜₐₗ)

where:

P_{ci} is the probability that when choosing the next image to display, the value i will be chosen for category c

n_{ci} is the number of times that the searcher has clicked on an item with the value i for its category c

N_{c} is the number of different values of category c

nₜₒₜₐₗ is the total number of clicks by the searcher in this session

For example, if there are eleven different designers and eight different garment types, there would initially be a 1 in 11 chance that ‘Designer Paul’ would be the designer chosen for the first item to display and a 1 in 8 chance that the garment would be a jacket. If the searcher selects a Designer Paul jacket, then the weightings are modified such that the probability that the second item displayed would be another item by the same designer rises from 1/11 (0.091) to 2/12 (0.167), and the chance of getting another jacket would be weighted to rise from ⅛ (0.125) to 2/9 (0.222). (It can easily be seen that the probability of getting another jacket from the same designer is still very small, at 1/27=0.037, but this is greater than the random probability of 1/88=0.011. The increments to the probabilities of choosing particular category values continue to accumulate throughout the user session. Note that the initial weightings do not take account of the number of available items in each category—each designer has an equal chance of being selected initially, however many of his individual products appear in the database.

Once the random selection process has decided on the category values for the next item, the database of items (13) is searched by the selection processor (17) to identify items that match those values. If more than one item satisfies these criteria, one of them is chosen at random with equal probability

The session recording database 15 is consulted to ensure that items that have already been suggested are not repeated (step 27), with another selection having the same criteria being made if possible (step 26). If a predetermined number of attempts to select an item having these criteria fail (because all such items have previously been selected, or if there is no item in the database with the set of category values, a counter (system 271) times out and a new set of category values is generated (return to step 25).

The selection processor 17 next passes the selected items to the output port 18 for onward transmission. At the user terminal, each suggestion offered by the system is added to the display, displacing the item having the greatest “age” (step 28).

This method is simple and computationally efficient, and can readily be extended to a multi-user situation as will be discussed. It also tends to focus the search rapidly because the percentage change of the probability resulting from a reward is largest when that value for the category has not been rewarded much before (change from 1/11 (0.091) to 2/12 (0.167) is bigger than, later in session, 33/217 (0.152) to 34/218 (0.156). This might or might not be an advantage depending on what is a good mix of focus versus search. It would be possible to use a different function relating selections to probabilities if required.

However, the search is biased towards showing the searcher items with unusual category value combinations: for example there might be several different Designer Paul grey jackets for adults but only one Designer Paul red trousers for adults. Furthermore, its efficiency will be adversely affected if the space of possible category value combinations is sparsely populated with actual items i.e. if most randomly generated sets of category values do not correspond to any item in the database, resulting in the algorithm having to “re-roll the dice” many times before hitting on a combination of values which does match an item.

For the purpose of the embodiment of FIG. 3, links are defined between certain items, as shown in FIG. 10. These links may relate to individual attributes by which the items are categorised, or may be determined empirically by research data indicative of searcher preferences. In practice, both methods of determining such associations may be used to define the links illustrated in FIG. 10

The processes of FIG. 3 (steps 30, 31, 32, and 33) follow a similar procedure to that of FIG. 2 (steps 20, 21, 22, 23) up to the point where the evolution of the search space departs from random, as the search strategy employed is different. In the embodiment of FIG. 3 a predetermined neighbour list is generated for each item as shown in the right hand column of FIG. 8 and indicated by the links between items in FIG. 10. It should be noted that a link could relate to any connection that may exist between the two items. For example market research data indicating that purchasers of a given item commonly also buy another item may be used to generate such a link between otherwise apparently unrelated items. The links may all be of unit value, in which case there is an equal probability of choosing any neighbour, or may take real values between 0 and 1, in which case the probability of choosing any neighbour is proportional to the value, or ‘weighting’, of the link.

In this embodiment an item is selected from the neighbour list of the previously selected item (step 36), and is displayed (step 38). In this way the display is made to “evolve” towards a group of items that are all either selected by the user, or linked to such items. As in the embodiment of FIG. 2, a check is made (step 37) to avoid duplication, and a further selection from the neighbour list made if possible step 371, step 36 repeated) or, if no such item is available, a random selection is made (step 361). The selection processor 17 next passes the items selected (in step 36 or 361) to the output port 18 for onward transmission. At the user terminal, each suggestion offered by the system is added to the display, displacing the item having the greatest “age” (step 38).

In a third embodiment, shown in FIG. 11, the search space is organised using links between items as in the embodiment of FIG. 3. However, in this case the next item to display is chosen probabilistically from all items in the database, more like the embodiment of FIG. 2. The links are used to allow the ‘reward’ of clicking on one item to spread to neighbouring items and hence increase the probability that those items will be chosen for display by the biased random selector.

On each iteration, one item is selected at random from the database (step 46) for display. Except on the first iteration, when all items are equally likely to be displayed, the probabilities of individual items being selected for display are weighted according to the results of previous iterations. A check is first made (step 47) to ensure the item has not been displayed before (in which case a new selection is made), and the newly selected item is added to the display, displacing the oldest (step 48). The ages of the items on display are then incremented. The user may then select an item from the display (step 42). If such a selection is made, the weightings of each item in the database linked to the selected item are increased (step 45), so that on subsequent iterations the selection is biased towards items in which the user has previously shown interest. The user is also offered the option of buying the selected item (step 49) as in the other embodiments.

Another item is then selected from the database (step 46), using the adjusted weightings. If after a predetermined interval no selection is made by the user (step 42) a selection is made based on the existing weightings (step 46)

Taking the same example as the previous embodiment, in this case an M×M matrix is created where M is the total number of items. Each row corresponds to an item, and each entry in that row is a number indicating the strength of association between that item and another item.

There is also a vector with M terms, which is updated as the searching session goes on. Each term pₙ of the vector represents the probability that the corresponding item n will be selected. Initially, all terms pₙ are set equal.

The next item to show is chosen randomly, taking into account the probability factors pₙ.

The vector is updated in response to the searcher's clicks as follows:

i) the searcher clicks on an item

ii) the row in the M×M matrix corresponding to that item is found

iii) the values of the terms in that row are added to the vector

iv) the vector is normalised so that the sum of terms is equal to M

This process gives a fine granularity of relationships between items. It needn't be tied to categories (if we want to make a grey jacket by one designer highly associated with an olive shirt by a different designer, we can). The relationships need not be symmetrical (people who like the jacket could be shown the shirt but not vice versa). The rapidity with which this method focuses the search can be set by parameterising the function describing the update of the matrix. This allows the system operator or even the searcher to alter the ‘exploitation versus exploration’ of the algorithm.

To avoid loss of information about a searcher's clicking behaviour, which would otherwise occur when the single updated vector is used in this method, the history of clicks may be used to make inferences about the main driver(s) of the searcher's search (e.g. looking for red things). This may allow faster focus than relying on this information being implicitly recovered by the item-to-item links method. To carry out this variant, there are three steps

Firstly, a set of ‘hypothesis’ vectors, each containing M binary terms are produced. A ‘1’ in the Mth position means ‘the Mth item conforms to this hypothesis’. For example, the hypothesis might be ‘red items’ and the vector would simply have a 1 in each position corresponding to a red item.

Next, a history vector is maintained where the Mth term is incremented whenever the searcher clicks on item M

The history vector is compared with the hypothesis vectors to infer which are the most likely explanations for user behaviour.

This process allows the extraction of comprehensible information, such as a preference by a particular customer for the colour red. With enough data (a long single session, or many users' short sessions) it may allow the formulation of new hypotheses, which also retain some explanatory meaning and hence might be useful to retailers.

These embodiments may be developed in a number of ways to make use of correlations between users. Two approaches are discussed here, one linked to purchased items and another relying only on navigation behaviour.

In the first, data is gathered from the searching sessions of many users over time. Information can be retrieved relating to the most popular purchased items and, for each item in the database. Information can also be stored relating to the number of times over the history of user sessions that selecting one specified item at some point in the session correspond to eventual purchase of some other specified item. (e.g. we record 1000 user sessions and find that there were fifteen occasions when a user who eventually bought the Designer Paul grey jacket had rewarded the Designer Peter green sweater. The sweater is now linked to the jacket with a weighting of 15).

When a new session starts, this information may be used to preferentially display a ‘top selling’ item. This could be done at random throughout the session, or particularly when the user has not rewarded any items for a while. The top selling item to display is picked by looking at the history of selections during the current session. Each item selected will have a link of a certain strength (possibly zero) relating it to each of the top sellers. For each top seller the link strengths of rewarded items are summed. The item to display is then chosen from those top sellers with a probability proportional to the sum of link strengths.

An alternative approach relies on the search space being navigated using item-to-item links and can be applied to the embodiments of FIGS. 3 and 12. It uses the selection behaviour of users to directly alter values in the matrix of links between items. Rewarding an item C and then rewarding an item D leads to an increment in matrix value at (c,d). If it is desired that the matrix is symmetrical, it can of course also increment (d,c). If the next rewarded item is E, there will be an increment to (d,e). There may also be a lesser increment for (c,e).

In FIG. 12 we are to imagine there were selections of items A, B and C which preceded the selection of D so there has already been a sequence of four selections during the user session.

FIG. 12 shows the result of the fifth reward i.e. clicking on item E. The primary incrementing function F₁ is applied to the matrix value relating the new rewarded item (E) to the previous (D). Secondary, tertiary, etc. functions F₂, F₃, F₄, etc increment links directly between items further down the chain and the newly selected item. Of course during the clicks on B, C and D there have already been increments to the links among A, B, C and D.

The alterations made to the matrix during a user session would be incorporated into the centrally held matrix and would thus affect the behaviour of the system for subsequent users.

In practical terms, it is anticipated that the functions applied to the matrix values would each result in small increments so that the behaviour of a single user does not grossly distort the search space.

The system operator may use the same process to generate new links between items, or alter the strength of existing links. An administrator browses the search space looking for items that are to be linked. For example, if the administrator sees three red items on the screen, clicking on each will make (or strengthen) the links between them.

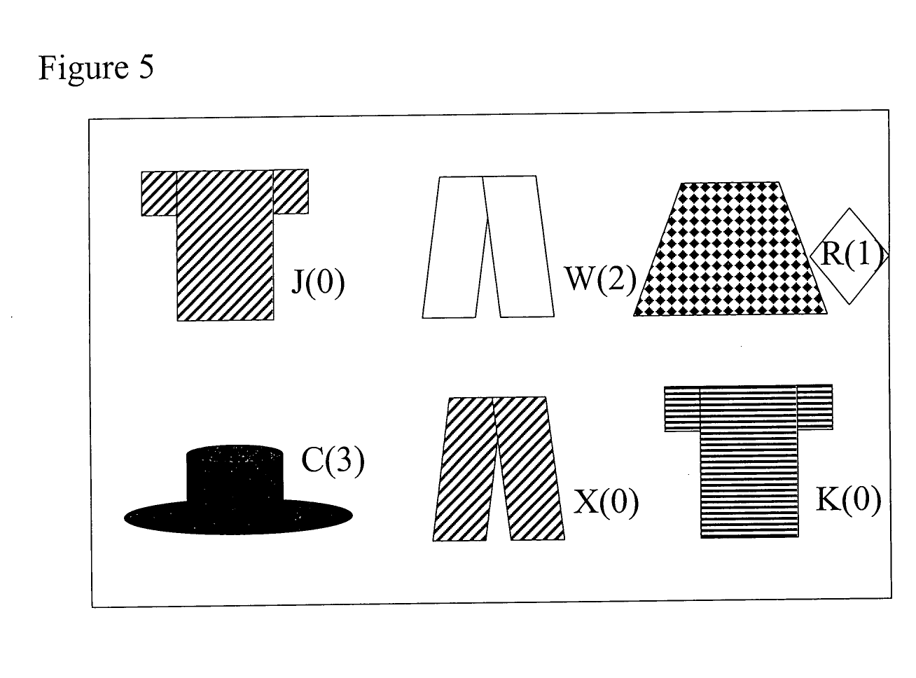

The displays generated by the systems of any of the embodiments may appear similar to the user, and typical displays are shown in FIGS. 4 to 7. The “age” value associated with each item is also shown in FIGS. 4 to 7, although this would not normally be displayed. From the display shown in FIG. 4, the user selects item “J”, and as previously described items X, K are added. These replace the items F, P with the highest “age” value, as shown by comparison of FIGS. 4 and 5.

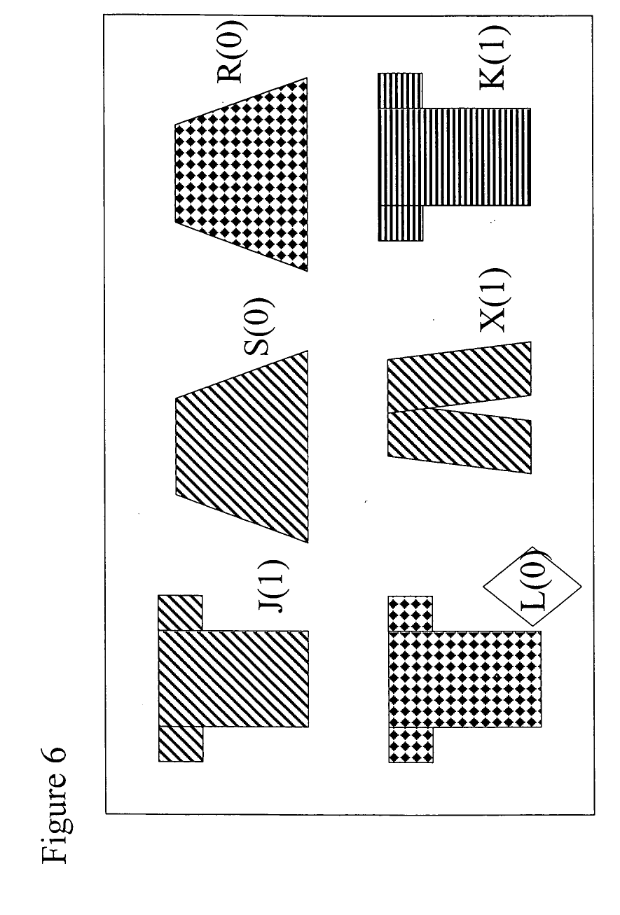

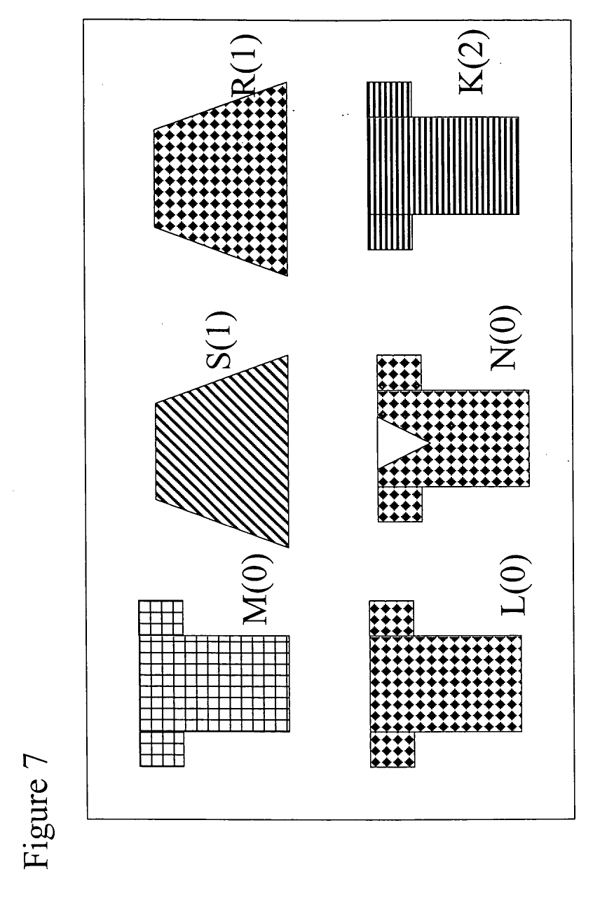

The age value of item “J” is re-set to zero. The process then continues: the user selecting, for example item “R” (FIG. 5), and items “S” and “L”, which each share an attribute with item “R” (if running the process of FIG. 2) or which are each on the neighbour list of item “R” (process of FIG. 3) are displayed (FIG. 6), replacing items “C” and “W” which now have the highest age values, and resetting the age value of item “R” to zero. Item “L” is next selected (FIG. 6), causing the display of two further items “N” and “M” (FIG. 7), replacing items “J” and “Y” which now have the highest age values.

As the session proceeds, the display will be increasingly populated with items that have either been recently selected by the user, or are descended from such items. The continued presence of selected items is achieved by the resetting of their ages to zero when they are selected or by moving top choices to a separate window on the display screen. The evolved garden therefore includes a mixture of items sharing some attributes with items the user found interesting, but probably including at least some things which were not in the searcher's mind when the session began. As each new item is selected in accordance with the previous few selections made by the user, the display will gradually evolve to show items likely to be of interest to the user. Suggestions that do not prompt the user to select them disappear from the system as their age value increments, and no similar suggestions are made.

When the user sees an item he wishes to order, he selects the item as before but now transmits a signal 29 (39, 49) indicating he wishes to purchase it, which is directed to the order-processing server 19.

As will be understood by those skilled in the art, any or all of the software used to implement the invention can be contained on various transmission and/or storage mediums, so that the program can be loaded onto one or more general purpose computers or could be downloaded over a computer network using a suitable transmission medium. The computer program may be embodied on any suitable carrier readable by a suitable computer input device, such as CD-ROM, optically readable marks, magnetic media, punched card or tape, or on an electromagnetic or optical signal.

1. Apparatus for selecting items from a database for display, comprising a data-storage means for storing, for each item, data indicative of the degree of similarity between that item and other items in the database;
input means for receiving a user input identifying a first item in said database
evolution processor means for specifying an evolved specification having a predetermined degree of similarity to the first item,
identifying from the database one or more variant items meeting the evolved specification,
selection means for selecting a second item from amongst the variant items
and output means for displaying an output identifying the selected second item.

2. Apparatus according to claim 1, comprising display means for displaying a plurality of items, and wherein the input means has means for selecting one of the displayed items to be the first item.

3. Apparatus according to claim 2, wherein the output means has means for controlling the display means to replace one of the plurality of items by the selected second item.

4. Apparatus according to claim 3, wherein the selected second item replaces the item which has been displayed for longest without having been selected.

5. Apparatus according to claim 4, further comprising means for generating a display of the selected items, means for allocating to each displayed item an age value, the age value being initially set at zero, means for periodically incrementing the age value of each displayed item, means for re-setting the age value of a given displayed item to zero in response to an input received by the input means identifying that item, and means for deleting from the display items having an age value greater than a predetermined value.

6. Apparatus according to claim 1, 2, 3, 4 or 5 wherein the data storage means comprises means for allocating to each item specified values for each of a set of attributes, the degree of similarity between any two items being identified by the number of attributes for which the two items have values in common.

7. Apparatus according to claim 6, further comprising attribute evolution generation means for generating a set of attribute values differing by a predetermined degree from the set of attribute values of the first item, and selection means for selecting from the database a second item having attribute values corresponding to the generated set

8. Apparatus according to claim 1, 2, 3, 4, or 5, wherein the data storage means comprises means for allocating to each item specified values for each of a set of attributes defining its degree of similarity to each other item

9. Apparatus according to claim 8, the evolution specification means comprising means for defining an evolved specification specifying a predetermined degree of similarity to the first item

10. Apparatus according to claim 8 or 9, wherein each specified value defines the presence or absence of an association between the two items

11. Apparatus according to claim 7 or 8, wherein the generated set of attribute values is determined according to the attributes of two or more previous inputs.

12. Apparatus according to claim 11 comprising recording means for recording the selections made on each cycle of operation of the apparatus, wherein the attribute generation means is arranged to generate a set of attributes related to attributes of items recorded as having been selected within a predetermined number of previous cycles of operation of the apparatus

13. Apparatus according to claim 6, 7, 8, 9, 10, or 11 comprising means for associating with each attribute a weighting value, and means for increasing the weighting values of the attributes associated with a first item on receipt of an input relating to the first item, and wherein the means for retrieving the second item is operable such that items having attributes allocated higher weightings have a greater probability of selection than those with lower-weighted attributes.

14. Apparatus according to any preceding claim, comprising recording means for recording the selections made on each cycle of operation of the apparatus, and wherein the selection means is arranged to constrain the selection of the second item to prevent selection of an item recorded by the recording means as having already been selected within a predetermined number of previous cycles of operation of the apparatus.

15. Method of selecting items from a database for display, comprising the steps of:
generating data indicative of the similarity between each item and other items in the database;
receiving an input identifying a first item in said database;
generating an evolved specification, identifying a predetermined degree of similarity to the first item,
selecting an item in the database meeting the evolved specification,
displaying the selected second item.

16. A method according to claim 15, wherein a plurality of items is displayed, the first item being one of the items so displayed.

17. A method according to claim 16, being an iterative process wherein the selected second item is added to the display, a further input being received relating to one of the displayed items, for selection of a further item for display.

18. Method according to claim 16 or 17 wherein one of the plurality of displayed items is replaced by the selected second item.

19. A method according to claim 18, wherein each displayed item is allocated an age value, the age value being initially set at zero and incremented periodically, the age value of a given displayed item being reset to zero if that item is selected, and the age values being used to identify items for deletion from the display.

20. Method according to claim 19, wherein the selected second item replaces the item that has been displayed for longest without having been selected.

21. A method according to claim 18, 19, or 20 wherein the selection of the second item is constrained to prevent selection of the same item within a predetermined number of iterations of the process.

22. A method according to any of claims 15 to 21, wherein each item has allocated specified values for each of a set of attributes, the degree of similarity between items being identified by the number of attributes for which they have values in common.

23. A method according to claim 22, wherein the evolved specification is selected by generating a set of attribute values differing by a predetermined degree from the set of attribute values of the first item, and the second item is selected from the database from those having attribute values corresponding to the generated set of attribute values.

24. A method according to claim 23, wherein the evolved specification is determined according to the attributes of two or more previous inputs.

25. A method according to any of claims 15 to 21, wherein, for each item, an attribute set is defined, the terms of the attribute set representing the degree of similarity between that item and each other item.

26. Method according to claim 25, wherein the evolved specification is generated by specifying a predetermined value for the term of each attribute set relating to the first item.

27. Method according to claim 25 or 26, wherein each specified value defines the presence or absence of an association between the two items

28. A method according to claim 21, 22, 23, 24 or 25, wherein each attribute is associated with a weighting value, and wherein on receipt of an input relating to a first item, the weighting values of the attributes associated with the first item are increased, and wherein the evolved specification is generated such that items having attributes allocated higher weightings have a greater probability of selection than those with lower-weighted attributes.

29. A computer program for performing the steps of any of claims 15 to 28.

30. A computer program product directly loadable into the internal memory of a computer, comprising software code portions for performing the steps of any of claims 15 to 28 when said product is run on a computer.

31. A computer program product stored on a computer usable medium, comprising:
computer-readable program means for causing a computer to generate data indicative of the similarity between each item and other items in a database
computer-readable program means for causing the computer to receive an input identifying a first item in said database
computer-readable program means for generating an evolved specification, specifying a predetermined degree of similarity to the first item,
computer-readable program means for causing the computer to select an item in the database meeting the evolved specification,
computer-readable program means for causing the computer to generate a display of the selected second item.
